(19) United States
(12) Patent Application Publication
(10) Pub. No.: US 2025/0254488 A1
(43) Pub. Date: Aug. 7, 2025

(54) VIRTUAL ENVIRONMENT

(71) Applicant: Nokia Technologies Oy, Espoo (FI)

(72) Inventors: Antti Johannes ERONEN, Tampere (FI); Arto Juhani LEHTINIEMI, Tampere (FI); Jussi Artturi LEPPÄNEN, Tampere (FI)

(21) Appl. No.: 19/016,353

(22) Filed: Jan. 10, 2025

(30) Foreign Application Priority Data
Feb. 2, 2024 (GB) 2401365.8

(51) Int. Cl. H04S 7/00

(52) U.S. Cl. CPC H04S 7/306; H04S 7/304

(57) ABSTRACT

An apparatus, method and computer program is described comprising: obtaining a virtual audio signal (comprising virtual audio samples) from one or more virtual sound signals of a virtual environment for presentation to a user; processing the virtual audio samples based on first reverberation parameters to generate a first reverberation signal (based on a geometry of a real-world space) for samples up to a first threshold time following the respective virtual audio sample being obtained; processing the virtual audio samples based on second reverberation parameters to generate a second reverberation signal (based on a geometry of the virtual environment) for samples beyond a second threshold time following the respective virtual audio sample being obtained; and generating an audio output for presentation to the user based on a sum of the first and second reverberation signals.

### FIELD

The present specification relates to an apparatus, method and computer program for generating an audio output for presentation to a user in a virtual environment.

### BACKGROUND

Virtual reality (VR) is a rapidly developing area of technology in which one or both of video and audio content is provided to a user device. The user device may be provided with a live or stored feed from a content source, the feed representing a virtual reality space or world for immersive output through the user device. The audio may be spatial audio representing captured or composed audio from one or more objects. A virtual space or virtual world is any computer-generated version of a space, for example a captured real world space, in which a user can be immersed through a user device such as a virtual reality headset.

For the avoidance of doubt, references to virtual reality (VR) are also intended to cover related technologies such as augmented reality (AR), extended reality (XR) and mixed reality (MR).

### SUMMARY

According to a first aspect, there is described an apparatus comprising: means for obtaining (e.g. receiving or generating) a virtual audio signal from one or more virtual sound signals of a virtual environment for presentation to a user, wherein the virtual audio signal comprises a plurality of virtual audio samples; means for processing the virtual audio samples based on first reverberation parameters to generate a first reverberation signal for samples up to a first threshold time following the respective virtual audio sample being obtained, wherein the first reverberation parameters are dependent, at least in part, on a geometry of a real-world space (e.g. a room or a building) in which a user is located; means for processing the virtual audio samples based on second reverberation parameters to generate a second reverberation signal for samples beyond a second threshold time following the respective virtual audio sample being obtained, wherein the second reverberation parameters are dependent, at least in part, on a geometry of the virtual environment; and means for generating an audio output for presentation to the user, where the audio output is based, at least in part, on a sum of the first and second reverberation signals. The first and second thresholds times may be the same. The first and second threshold times may be different (e.g. the first threshold time could be later than the second threshold time or the second threshold time could be later than the first threshold time).

Some example embodiments further comprise means for processing a direct path virtual audio signal, wherein the audio output is based, at least in part, on a sum of the processed direct path audio signal, the first reverberation signal and the second reverberation signal. The said means for processing said direct path virtual audio signal may comprise means for filtering the direct path virtual audio signal based on room simulation dependent effects (such as distance-based attenuation, air absorption, source directivity etc.).

The first reverberation parameters may be based, at least in part, on boundaries of the real-world space. Alternatively, or in addition, the second reverberation parameters may be based, at least in part, on boundaries of the virtual environment.

In some example embodiments, the first reverberation parameters are defined such that the first reverberation signal generated by the processing of the virtual audio samples based on first reverberation parameters is audible to the user.

The first reverberation signal may comprise discrete directional reflections.

Some example embodiments further comprise a delay line for use in processing said virtual audio samples. Thus, the said virtual audio samples may be provided to the delay line.

Some example embodiments further comprise means for detecting a real-world object between a position of a virtual sound source and the user. The apparatus may further comprise means for determining the position of the real-world object. The apparatus may further comprise means for processing the virtual audio samples to generate a modelled diffracted audio signal in the event that a real-world object is detected between the position of the virtual sound signal and the user, wherein the audio output is based, at least in part, on a sum of the modelled diffracted audio signal, the first reverberation signal and the second reverberation signal.

Some example embodiments further comprise means for determining whether an amount of diffraction caused to the modelled diffracted audio signal is below a threshold level, wherein the means for processing the virtual audio signal is configured to generate the modelled diffracted audio signal based on an extended effective area of the real-world object in the event that the diffraction effect is below said threshold level.

Some example embodiments further comprise means for presenting the generated audio output to the user.

According to a second aspect, there is described a method comprising: obtaining a virtual audio signal from one or more virtual sound signals of a virtual environment for presentation to a user, wherein the virtual audio signal comprises a plurality of virtual audio samples; processing the virtual audio samples based on first reverberation parameters to generate a first reverberation signal for samples up to a first threshold time following the respective virtual audio sample being obtained, wherein the first reverberation parameters are dependent, at least in part, on a geometry of a real-world space in which a user is located; processing the virtual audio samples based on second reverberation parameters to generate a second reverberation signal for samples beyond a second threshold time following the respective virtual audio sample being obtained, wherein the second reverberation parameters are dependent, at least in part, on a geometry of the virtual environment; and generating an audio output for presentation to the user, where the audio output is based, at least in part, on a sum of the first and second reverberation signals. The first and second thresholds times may be the same.

Some example embodiments further comprise processing a direct path virtual audio signal, wherein the audio output is based, at least in part, on a sum of the processed direct path audio signal, the first reverberation signal and the second reverberation signal. Processing said direct path virtual audio signal may comprise filtering the direct path virtual audio signal based on room simulation dependent effects (such as distance-based attenuation, air absorption, source directivity etc.).

The first reverberation parameters may be based, at least in part, on boundaries of the real-world space. Alternatively, or in addition, the second reverberation parameters may be based, at least in part, on boundaries of the virtual environment.

In some example embodiments, the first reverberation parameters are defined such that the first reverberation signal generated by the processing of the virtual audio samples based on first reverberation parameters is audible to the user.

The first reverberation signal may comprise discrete directional reflections.

Some example embodiments further comprise detecting a real-world object between a position of a virtual sound source and the user. The method may further comprise determining the position of the real-world object. The method may further comprise processing the virtual audio samples to generate a modelled diffracted audio signal in the event that a real-world object is detected between the position of the virtual sound signal and the user, wherein the audio output is based, at least in part, on a sum of the modelled diffracted audio signal, the first reverberation signal and the second reverberation signal.

Some example embodiments further comprise determining whether an amount of diffraction caused to the modelled diffracted audio signal is below a threshold level, wherein processing the virtual audio signal includes generating the modelled diffracted audio signal based on an extended effective area of the real-world object in the event that the diffraction effect is below said threshold level.

Some example embodiments further comprise presenting the generated audio output to the user.

According to a third aspect, there is provided a computer-readable instructions which, when executed by a computing apparatus, cause the computing apparatus to perform (at least) any method as described herein (including the method of the second aspect described above).

According to a fourth aspect, there is provided a computer-readable medium (such as a non-transitory computer-readable medium) comprising program instructions stored thereon for performing (at least) any method as described herein (including the method of the second aspect described above).

According to a fifth aspect, there is provide an apparatus comprising: at least one processor; and at least one memory including computer program code which, when executed by the at least one processor, causes the apparatus to perform (at least) any method as described herein (including the method of the second aspect described above).

According to a sixth aspect, there is provided a computer program comprising instructions which, when executed by an apparatus, cause the apparatus to: obtain a virtual audio signal from one or more virtual sound signals of a virtual environment for presentation to a user, wherein the virtual audio signal comprises a plurality of virtual audio samples; process the virtual audio samples based on first reverberation parameters to generate a first reverberation signal for samples up to a first threshold time following the respective virtual audio sample being obtained, wherein the first reverberation parameters are dependent, at least in part, on a geometry of a real-world space in which a user is located; process the virtual audio samples based on second reverberation parameters to generate a second reverberation signal for samples beyond a second threshold time following the respective virtual audio sample being obtained, wherein the second reverberation parameters are dependent, at least in part, on a geometry of the virtual environment; and generate an audio output for presentation to the user, where the audio output is based, at least in part, on a sum of the first and second reverberation signals.

According to a seventh aspect, there is provided an apparatus comprising (at least): an input (or some other means) for obtaining a virtual audio signal from one or more virtual sound signals of a virtual environment for presentation to a user, wherein the virtual audio signal comprises a plurality of virtual audio samples; an audio processor (or some other means) for processing the virtual audio samples based on first reverberation parameters to generate a first reverberation signal for samples up to a first threshold time following the respective virtual audio sample being obtained, wherein the first reverberation parameters are dependent, at least in part, on a geometry of a real-world space in which a user is located; the audio processor (or some other means) for processing the virtual audio samples based on second reverberation parameters to generate a second reverberation signal for samples beyond a second threshold time following the respective virtual audio sample being obtained, wherein the second reverberation parameters are dependent, at least in part, on a geometry of the virtual environment; and an output module (or some other means) for generating an audio output for presentation to the user, where the audio output is based, at least in part, on a sum of the first and second reverberation signals.

### BRIEF DESCRIPTION OF THE DRAWINGS

Example embodiments will now be described, by way of example only, with reference to the following schematic drawings, in which:

FIG. 1 is a schematic illustration of an example VR display system;

FIG. 2 is a schematic view of a scenario in accordance with an example embodiment;

FIG. 3 is a schematic view of a scenario in accordance with an example embodiment;

FIG. 4 is a plot showing an example room audio impulse response in accordance with an example embodiment;

FIG. 5 is a flow chart showing an algorithm in accordance with an example embodiment;

FIG. 6 is a flow chart showing an algorithm in accordance with an example embodiment;

FIG. 7 is a schematic view of a scenario in accordance with an example embodiment;

FIG. 8 is a block diagram of a system in accordance with an example embodiment;

FIG. 9 is a block diagram of a system in accordance with an example embodiment;

FIG. 10 is a block diagram of a reverberator in accordance with an example embodiment;

FIG. 11 is a flow chart showing an algorithm in accordance with an example embodiment;

FIG. 12 is a schematic view of a scenario in accordance with an example embodiment;

FIG. 13 is a schematic view of a scenario in accordance with an example embodiment;

FIG. 14 is a flow chart showing an algorithm in accordance with an example embodiment;

FIG. 15 is a schematic view of a scenario in accordance with an example embodiment;

FIG. 16 is a block diagram of components of a system in accordance with an example embodiment; and

FIG. 17 shows an example of tangible media for storing computer-readable code which when run by a computer may perform methods according to example embodiments described above.

### DETAILED DESCRIPTION

The scope of protection sought for various embodiments of the disclosure is set out by the independent claims. The embodiments and features, if any, described in the specification that do not fall under the scope of the independent claims are to be interpreted as examples useful for understanding various embodiments of the disclosure.

In the description and drawings, like reference numerals refer to like elements throughout.

Virtual reality (VR) is a developing area of technology in which one or both of video and audio content is provided to a user device. The user device may be provided with a live or stored feed from a content source, the feed representing a virtual reality space or world for immersive output through the user device. The audio may be spatial audio representing captured or composed audio from multiple audio objects. A virtual space or virtual world is any computer-generated version of a space, for example a captured real-world space, in which a user can be immersed through a user device such as a virtual reality headset. The virtual reality headset may be configured to provide spatial audio content to the user, e.g. through the use of headphones incorporated within the headset.

Mixed Reality (MR) is an area of technology in which real and virtual worlds are combined such that physical and digital objects co-exist and interact in real time. For example, a virtual dog may be associated with a particular user within the Mixed Reality environment, but other users may be able to see and interact with the virtual dog. In such a world, there may be a large number of users and a large number of virtual objects that co-exist.

Augmented Reality (AR) refers to a real-world view that is augmented by computer-generated sensory input. In the context of the present specification, the term Mixed Reality is intended to encompass Augmented Reality.

Extended Reality (XR) is generally used as a catch-all term that encompasses Augmented Reality, Mixed Reality, Virtual Reality and similar concepts.

In overview, embodiments described herein relate generally to audio processing of audio signals from one or more objects in an audio scene, for example a virtual reality (VR) audio scene or an augmented reality (AR) audio scene, although the methods and systems described herein are not limited to such scenes. The audio scene may be accompanied by a video scene comprising visuals of objects in a visual virtual world, but this is not essential.

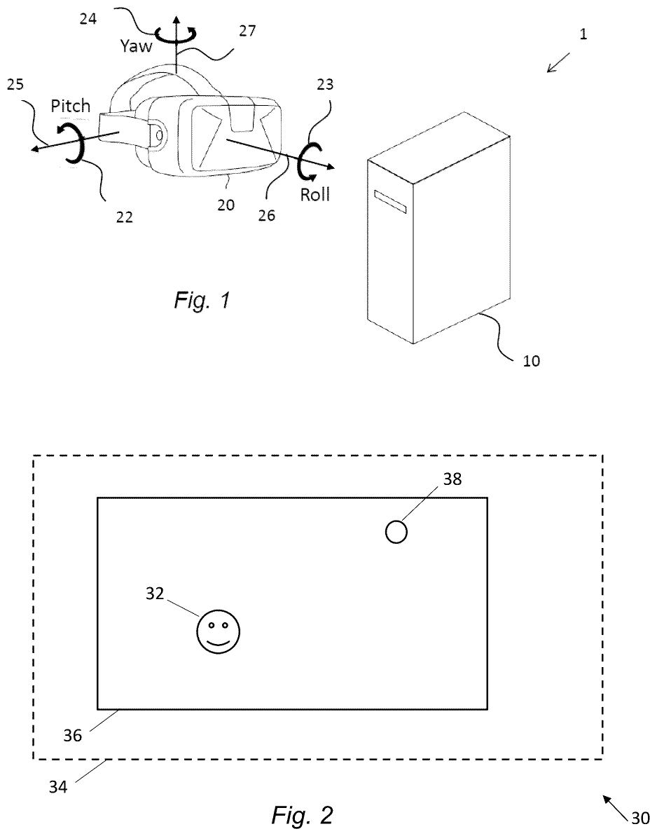

FIG. 1 is a schematic illustration of a virtual reality display system 1 which represents user-end equipment. The virtual reality display system 1 includes a user device in the form of a virtual reality headset 20, for displaying visual data for a virtual reality space, and a virtual reality media player 10 for rendering visual data on the virtual reality headset 20. In some example embodiments, a separate user control (not shown) may be associated with the virtual reality display system 1, e.g. a hand-held controller.

In the context of this specification, a virtual space or world is any computer-generated version of a space, for example a captured real-world space, in which a user can be immersed. In some example embodiments, the virtual space may be entirely computer-generated. The virtual reality headset 20 may be of any suitable type. The virtual reality headset 20 may be configured to provide virtual reality video and/or audio content data to a user. As such, the user may be immersed in virtual space.

The virtual reality headset 20 receives the virtual reality content data from the virtual reality media player 10. The virtual reality media player 10 may be part of a separate device which is connected to the virtual reality headset 20 by a wired or wireless connection. For example, the virtual reality media player 10 may include a games console, or a PC configured to communicate visual data to the virtual reality headset 20. Alternatively, the virtual media player may comprise a mobile phone, smartphone or similar device configured to play context through its display.

Alternatively, the virtual reality media player 10 may form part of the virtual reality headset 20.

The virtual reality display system 1 may include means for determining the spatial position of the user and/or orientation of the user's head. This may be by means of determining the spatial position and/or orientation of the virtual reality headset 20. Over successive time frames, a measure of movement may therefore be calculated and stored. Such means may comprise part of the virtual reality media player 10. Alternatively, the means may comprise part of the virtual reality headset 20. For example, the virtual reality headset 20 may incorporate motion tracking sensors which may include one or more of gyroscopes, accelerometers and structured light systems. These sensors generate position data from which a current visual field-of-view (FOV) is determined and updated as the user, and so the virtual reality headset 20, changes position and/or orientation. The virtual reality headset 20 may comprise two digital screens for displaying stereoscopic video images of the virtual world in front of respective eyes of the user, and also two headphones, earphone or speakers for delivering audio. The example embodiments herein are not limited to a particular type of virtual reality headset 20.

In some example embodiments, the virtual reality display system 1 may determine the spatial position and/or orientation of the user's head using the above-mentioned six degrees-of-freedom method. As shown in FIG. 1, these include measurements of pitch 22, roll 23 and yaw 24, and also translational movement in Euclidean space along side-to-side, front-to-back and up-and-down axes 25, 26, 27.

The virtual reality display system 1 may be configured to display virtual reality content data to the virtual reality headset 20 based on spatial position and/or the orientation of the virtual reality headset. A detected change in spatial position and/or orientation, i.e. a form of movement, may result in a corresponding change in the visual and/or audio data to reflect a position or orientation transformation of the user with reference to the space into which the visual data is projected. This allows virtual reality content data to be consumed with the user experiencing a 3D virtual reality environment.

Audio data may be provided to headphones provided as part of the virtual reality headset 20 (in addition to, or instead of, visual data). The audio data may represent spatial audio source content. Spatial audio may refer to directional rendering of audio in the virtual reality space or world such that a detected change in the user's spatial position or in the orientation of their head may result in a corresponding change in the spatial audio rendering to reflect a transformation with reference to the space in which the spatial audio data is rendered.

FIG. 2 is a schematic view of a scenario, indicated generally by the reference numeral 30, in accordance with an example embodiment. The scenario comprises a user 32. The user is within a virtual space (or virtual room) 34, but is also within a real-world space 36 (such as a virtual room). In the example scenario 30, the real-world space 36 is smaller than the virtual space 34 (indeed, from the viewer perspective, the real-world space 36 is entirely enclosed within the virtual space 34). Note that the scenario 30 is provided by way of example only; alternatives are possible, for example the real-world space 36 may overlap with the virtual space 34 rather than being entirely within the virtual space.

In the scenario 30, a virtual object 38 is presented within the virtual space 34. The virtual object 38 is an audio object (or has an audio component). Audio rendering of the virtual object 38 to the user 32 is therefore required.

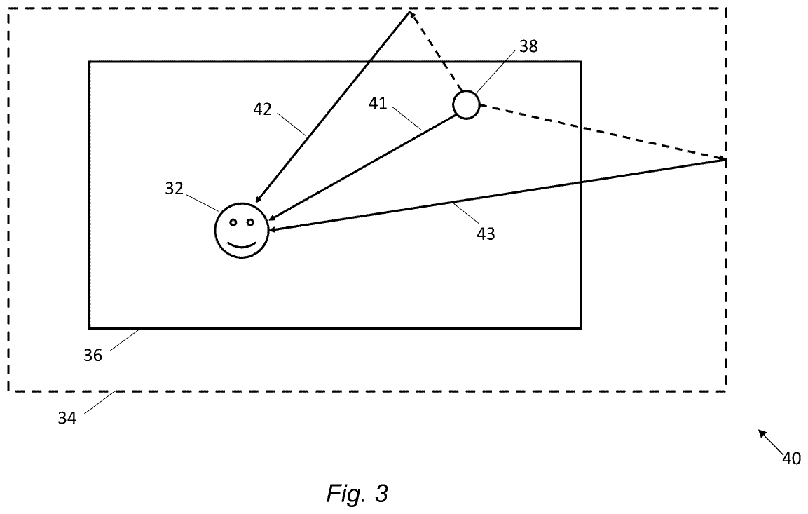

FIG. 3 is a schematic view of a scenario, indicated generally by the reference numeral 40, in accordance with an example embodiment. The scenario 40 includes the user 32, the virtual space 34, the real-world space 36 and the virtual object 38 described above.

In the scenario 40, the user 32 is hears sound waves that propagate from the virtual object 38. Specifically, the user 32 hears sound waves 41 that travel directly from the virtual object 38 to the user and also hears sounds waves that propagate from the virtual object 38 and reflect from the boundary of the virtual space 34. Examples of reflected audio received at the user 32 include sound waves 42 and 43 shown in FIG. 3.

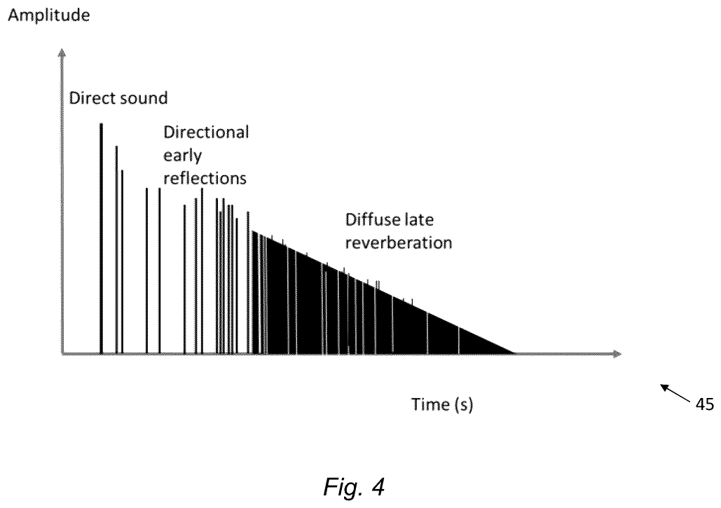

FIG. 4 is a plot, indicated generally by the reference numeral 45, showing an example room audio impulse response in accordance with an example embodiment. The room audio impulse response 45 characterizes the reflections and reverberation in a space (such as the virtual space 34 or the real-world space 36). The impulse response 45 can be used to generate audio of the virtual object 38 for presentation to the user 32.

The impulse response 45 relates to reverberations that are audible to the user 32. Reverberation refers to the persistence of sound in a space after the actual sound source has stopped. Different spaces are characterized by different reverberation characteristics. For conveying spatial impression of an environment, reproducing reverberation perceptually accurately may be important.

The impulse response 45 includes direct sound (e.g. relating to sound waves 41 that travel directly from the virtual object 38 to the user 32). After the direct sound, the listener (e.g. the user 32) hears directional early reflections. After some point, individual reflections can no longer be perceived but the listener hears diffuse, late reverberation. The starting time of the diffuse late reverberation may be referred as the pre-delay.

As discussed in detail below, reverberations as defined by the impulse response 45 can be rendered using, for example, a Feedback-Delay-Network (FDN) reverberator with a suitable tuning of delay line lengths. FDNs allow the control of reverberation times (e.g. RT60 reverberation time) and the energies of different frequency bands (e.g. individually). Thus, FDNs can be used to render the reverberation based on the characteristics of a virtual room. The reverberation times and the energies of the different frequencies are affected by the frequency-dependent absorption characteristics of the room.

Reverberation spectrum or level can be controlled using a diffuse-to-direct ratio filter, which describes the ratio of the energy (or level) of reverberant sound energy to the direct sound energy (or the total emitted energy of a sound source).

Individual early reflections can be synthesized as delayed and attenuated versions of the original sound. They can be filtered with synthetic material filters which are implemented, e.g., as low order infinite impulse response (IIR) filters. These filters to some extent emulate the frequency dependent material absorption properties of different materials but some or all more complex acoustic effects may be neglected by this approach.

Users can consume VR content with artificial reverberation. For example, the user 32 can listen to a virtual scene including the virtual space 34. That virtual space could, for example, be a large cathedral or some other large space. A problem with this arrangement is that if the virtual space 34 is larger than the real-world space 36 (in any or all dimensions), there is a risk of the user 32 bumping into the walls of the real-world space 36 when moving around the virtual space 34.

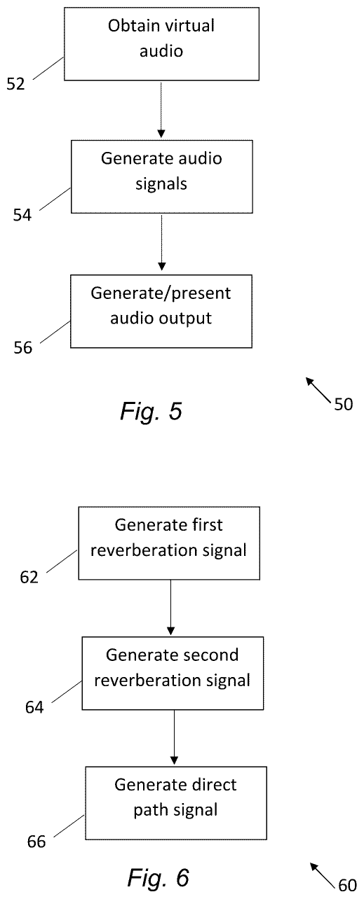

FIG. 5 is a flow chart showing an algorithm, indicated generally by the reference numeral 50, in accordance with an example embodiment.

The algorithm 50 starts at operation 52, where a virtual audio signal is obtained (e.g. received or generated) from one or more virtual sound signals of a virtual environment (e.g. sound signals associated with the virtual object 38) for presentation to a user (e.g. the user 32). The virtual audio signal comprises a plurality of virtual audio samples.

At operation 54, the virtual audio signal is processed to generate audio signals to be presented to the user. As discussed in detail below, the virtual audio signal may be processed based, at least in part, on the room response (defining room/space reverberations as discussed above, for example).

At operation 56, an audio output is generated based on the processed audio data. The generated audio may be rendered to the user (e.g. using headphones).

FIG. 6 is a flow chart showing an algorithm, indicated generally by the reference numeral 60, in accordance with an example embodiment. The algorithm 60 may be used in an example implementation of the operation 54 described above.

At operation 62 of the algorithm 60, the virtual audio samples obtained in the operation 52 are processed based on first reverberation parameters to generate a first reverberation signal for samples up to a first threshold time following the respective virtual audio sample being obtained. The reverberation parameters are dependent, at least in part, on a geometry of a real-world space in which a user is located (such as the real-world space 36). The real-world space may be a room in which the user is currently located. The first reverberation signal may comprise discrete directional reflections.

At operation 64 of the algorithm 60, the virtual audio samples obtained in the operation 52 are processed based on second reverberation parameters to generate a second reverberation signal for samples beyond a second threshold time following the respective virtual audio sample being obtained. The second reverberation parameters are dependent, at least in part, on a geometry of the virtual environment (such as the virtual space 34). Note that the first and second threshold times may be the same (e.g. to mirror the time at which directional reflections would no longer perceivable, as discussed above with reference to FIG. 4), so that for time periods up to that threshold time, the first reverberations parameters are used, and for time periods after the threshold time, the second reverberations parameters are used. The second reverberation signal may be such that discrete directional reflections are not perceptible to a listener.

At operation 66 of the algorithm, the virtual audio samples obtained in the operation 52 are processed based on parameters relating to a direct path between the object and the user. The operation 66 may include filtering the direct path virtual audio signal based on room simulation dependent effects, such as based on distance based attention, air absorption, source directivity etc.

As discussed above, in the operation 56 of the algorithm 50, an audio signal is generated for presentation to the user. That audio signal may be based, at least in part, on a sum of the first reverberation signal (generated in the operation 62), the second reverberation signal (generated in the operation 64) and the direct path signal (generated in the operation 66).

It should be noted that although the algorithm 60 presents steps in a sequence, this is not essential to all example embodiments. For example, some or all of the operations 62 to 66 may be implemented in a different order, or in parallel. Moreover, one or more of the operations may be omitted. For example, some example embodiments do not include the direct path signal, so that the operation 66 may be omitted.

The algorithm 60 may be used to in the reproduction of reverberation in audio rendering systems (e.g. 6DoF audio rendering systems) based, first, on virtual scene geometry and reverberation parameters and, second, on real room geometry (and optionally materials). As discussed above, the algorithm 60 is configured to render later reverberations using virtual scene geometry and reverberation parameters and to render earlier reflections (and optionally acoustic occlusion and/or acoustic diffraction) using real room geometry or real room objects. In this way, an audible indication can be achieved in acoustic rendering related to real room geometry or objects while still maintaining virtual rendering to achieve an immersive audio experience.

In some example embodiments, the system uses a virtual object created around the real room object for rendering the early reflections, acoustic occlusion, or acoustic diffraction, and creates the virtual object large enough so that an audible effect is created.

When the algorithms 50 and 60 are used, the user may receive an audible indication of real room physical boundaries or objects via sound. This may reduce the likelihood of a user accidentally bumping into such physical boundaries or objects.

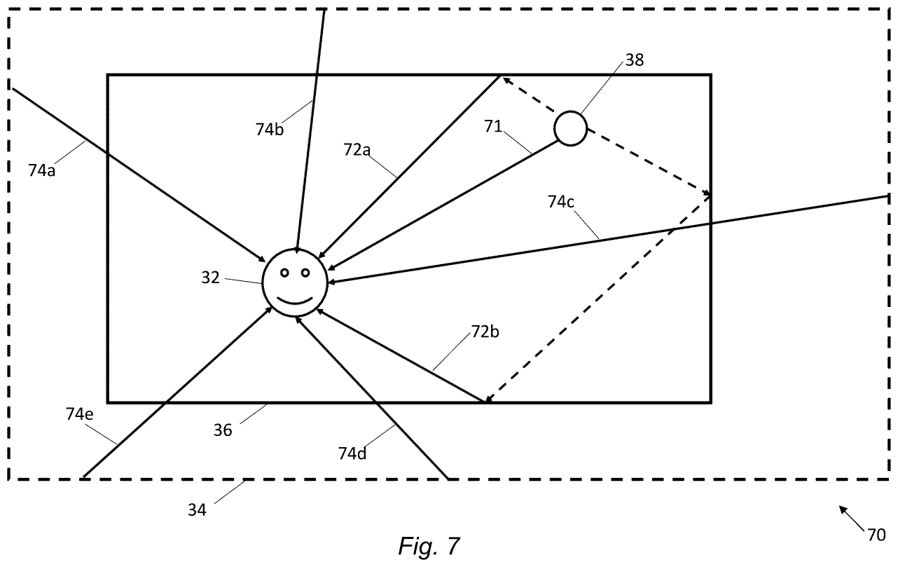

FIG. 7 is a schematic view of a scenario, indicated generally by the reference numeral 70, in accordance with an example embodiment. The scenario 70 shows an example implementation of the algorithm 60 described above. The scenario 70 includes the user 32, the virtual space 34, the real-world space 36 and the virtual object 38 described above.

In the scenario 70, the user 32 is presented with a first reverberation signals 72a and 72b processed based on first reverberation parameters dependent on the geometry of the real-world space 36, second reverberation signals 74a, 74b, 74c, 74d and 74e based on second reverberation parameters dependent on the geometry of the virtual space 34, and direct path signals 71 processed based on parameters relating to a direct path between the virtual object 38 and the user 32.

Thus, early reflections (e.g. reverberations signals 72a and 72b) may be perceived by the user 32 to bounce from the physical room boundary (of the real-world space 36), thereby creating a subtle but perceivable effect of proximity of physical walls, especially when the user is close to them. Acoustic materials (or parameters of acoustic materials) may be selected for generating the first parameters so that the impact of the early reflections is audible to the user. Later reverberations (e.g. reverberation signals 74a to 74e) are rendered according based on parameters of the virtual space 34.

In the example scenario 70, one first reverberation signal 72a is modelled as having bounced off one wall of the real-world space and the other first reverberation signal 72b is modelled as having bounced off two walls of the real-world space. The reverberation signal 72b may therefore arrive slightly later and may have a different attenuation to the reverberation signal 72a. As discussed in detail below, this effect may be achieved using a delay line and/or filters.

In the example scenario 70, the second reverberations signals 74a to 74e are each shown as being directional (i.e. arriving from different parts of the virtual space 34). As discussed in detail herein, the second reverberation signals may, in fact, be rendered such that they are not directional (or such that the direction is not perceptible to the user 32).

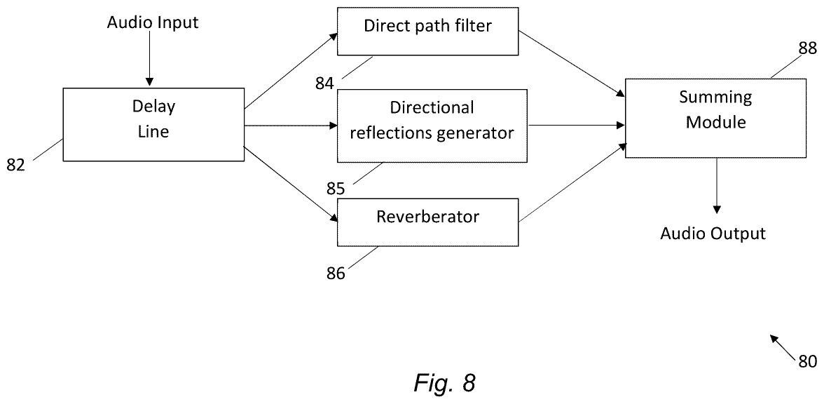

FIG. 8 is a block diagram of a system, indicated generally by the reference numeral 80, in accordance with an example embodiment. The system 80 comprises a delay line 82, a direct path filter 84, a directional reflections generator 85, a reverberator 86 and a summing module 88.

The system 80 may be used for VR audio rendering in example embodiments. In particular, the system 80 may be used in an example implementation of the algorithm 60, as discussed further below.

The delay line 82 receives audio samples (e.g. audio related to the virtual object 38). The samples are stored within the delay line 82 so that a plurality of audio samples over time are stored. The delay line 82 provides audio data from different time periods to the direct path filter 84, the directional reflections generator 85 and the reverberator 86.

The direct path filter 84 obtains recent audio data from the delay line 82 and filters that data to provide a direct path signal (thereby implementing operation 66 of the algorithm 60 described above).

The directional reflections generator 85 obtains relatively recent audio data from the delay line 82 (e.g. audio up to a first threshold time) and uses that data to generate an estimate of directional early reflection dependent on real-world geometry (e.g. based on the geometry of the real-world space 36). Accordingly, the directional reflections generator 85 can be used to implement the operation 62 of the algorithm 60. By way of example, the first reverberation signals 72a and 72b may be generated by the directional reflections generator 85, for example based on outputs of the delay line 82 having different delays.

The reverberator 86 generates diffuse later reverberations dependent on virtual room generator (e.g. based on the geometry of the virtual space 34). Accordingly, the reverberator can be used to implement the operation 64 of the algorithm 60. The reverberator 86 may therefore be used to generate the second reverberations signals 74a to 74e described above.

The summing module 88 generates an audio output based on the sum of the outputs of the direct path filter 84, the directional reflections generator 85 and the reverberator 86.

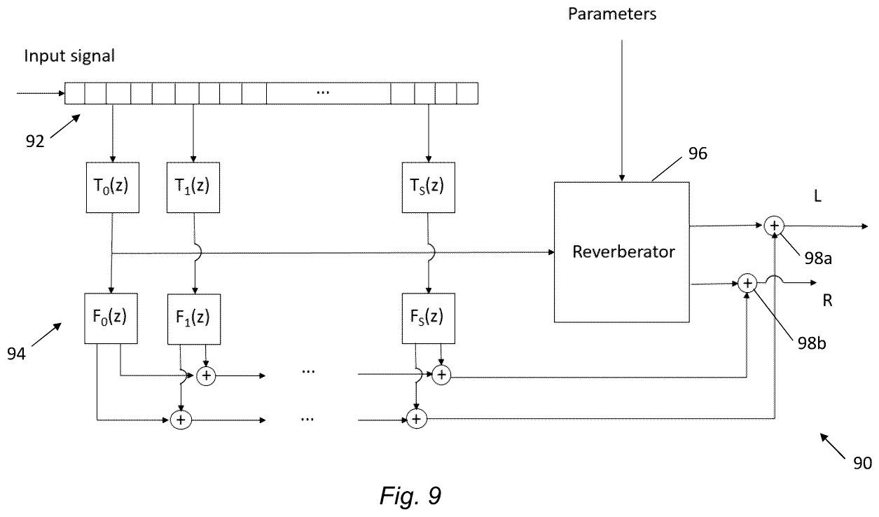

FIG. 9 is a block diagram of a system, indicated generally by the reference numeral 90, in accordance with an example embodiment. The system 90 is an example implementation of the system 80, incorporated a delay-line based Feedback-Delay-Network (FDN) reverberator.

The system 90 comprises a delay line 92, a filter arrangement 94, a reverberator 96, a first summing module 98a and a second summing module 98b. The delay line 92 may be used to implement the delay line 82 described above. The filter arrangement 94 may be used to implement the direct path filter 84 and the directional reflections generator 85 described above. The reverberator 96 may be used to implement the reverberator 86 described above. The first and second summing modules 98a and 98b may be used to implement the summing module 88 described above.

The system 90 receives a (usually) acoustically dry input signal (such as object audio) at the input of the delay line 92. This delay line 92 is usually relatively long (e.g., processing multiple seconds of audio data) and may be implemented, for example, using a circular buffer. The delay line 92 may have exactly one input and multiple (at least one) outputs with different (or the same) delays. The outputs of the delay line 92 correspond to direct travel path of sound, different early reflection paths, and outputs suitable for inserting to late reverberation generator. Simulation metadata controls the time delay applied for each output. For example, a 3.4 metre distance from the source to listener would correspond to a 10 ms delay for the direct sound path and with an example rendering sampling rate of 48 KHz this would mean that the output from the delay line for the direct path signal would come approximately 480 samples delayed in time compared to the input of the delay line. Similarly, early reflections will receive the appropriate delay value depending on the total length of the reflection paths. In the example embodiments described herein, real room geometry may be used to determine early reflection delays. The distance to the source in the virtual room can be used for calculating the distance traveled by the sound.

Direct path, early reflections, and late reverberation paths receive their own processing in the example system 90 (although some of these features may be combined in some example embodiments). The direct path may apply filter T0 that contains such room simulation dependent effects such as one or more of: distance-based attenuation, air absorption, and source directivity. This T0 filter may be a single filter or may comprise multiple cascaded modifications. After this step, the direct path can be spatialized into the direction corresponding to the listener and source positions in the virtual room. Such spatialization may depend on the target format of the system and can be, for example, vector-base amplitude panning (VBAP), binaural panning, or HOA-panning. Finally, the direct signal is fed to the common rendering unit. In many cases, the spatialization and rendering units can be combined into one unit.

The early reflection paths are separate for each early reflection sound propagation paths in the simulation. It may be possible to optimize them into fewer paths but in the context of some example embodiments, each is separate. The delay of each early reflection comes from the room simulation applied based on the real room geometry. There are filters Tk that are each similar to the direct path filter T0 and apply similar room simulation effects, such as source directivity and material absorption. The next step for early reflection paths is to similarly spatialize and render them for output.

The late reverberation path starts with the specific outputs from the delay line that are directed to the late reverberation generator (the reverberator 96). These outputs may depend on the specific type of the late reverberation generator and on the room simulation data. In this example embodiment, the late reverberator 96 is an FDN late reverberation generator. This FDN takes in the input signal, runs it through a network of feedback delays and then picks up output from different delay lines of the network for multiple spatial channels. Each delay line can be assigned to a different spatial channel for maximally diffuse reverberation. The reverberated channels can then be directed to spatialization and rendering steps to obtain spatialized late reverberation.

Delay line lengths of the reverberator 96 may be adjusted based on the virtual room geometry. Alternatively, or in addition, attenuation filters of the reverberator 96 may be adjusted based on the delay line lengths and the reverberation parameters (such as RT60 times).

The final output step adds together the direct path, the early reflection path, and the late reverberation path signals using the first and second summing modules 98a and 98b to generate reverberated output signals (left and right audio signals in this example embodiment).

In some example embodiments, the parameters of the reverberator 96 may be defined such that the processing of the virtual audio samples based on first reverberation parameters is audible to the user. By way of example, an energy level output by the reverberator 96 may be monitored during audio rendering to ensure that the audio output is above a threshold level (i.e. above a level that will be/should be audible to the user).

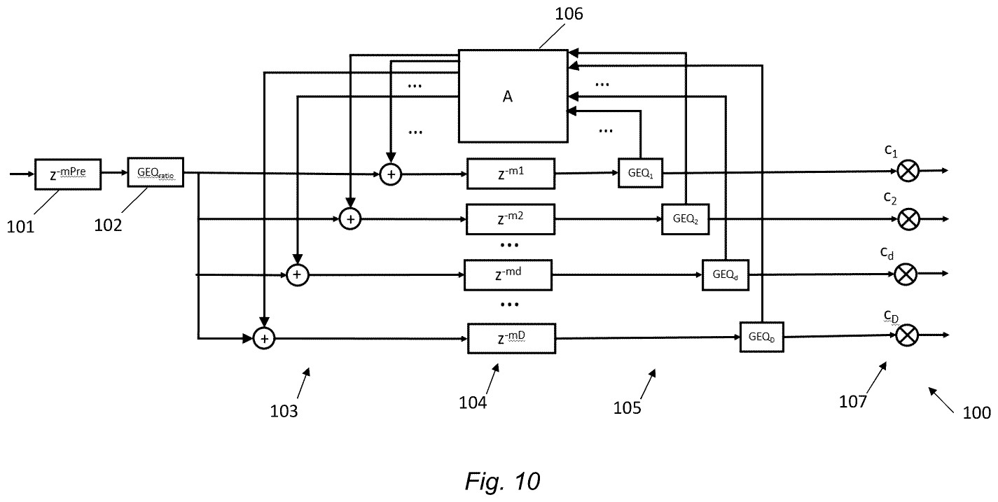

FIG. 10 is a block diagram of a reverberator, indicated generally by the reference numeral 100, in accordance with an example embodiment. The reverberator 100 is an example implementation of the reverberators 86 and 96 described above. The reverberator 100 is shown by way of example only; the skilled person will be aware of alternative reverberator implementations that could be used.

The reverberator 100 comprising a delay stage 101 (acting as a pre-delay line), a filter 102, a plurality of summing modules 103 (one for each of a plurality of channels), a plurality of delay stages 104 (one for each of the plurality of channels), a plurality of filters 105 (one for each of the plurality of channels), a feedback matrix 106 that couples the output of each of the plurality of channels to the summing module(s) 103 for the respective channels, and a plurality of output generator 107 (one for each of the plurality of channels).

The filter 102 is a reverberator ratio filter that can be used for controlling reverberation level and spectrum.

The delay stages 104 are delay lines have adjustable delay lengths. These delay lengths can be adjusted based on virtual room dimensions and are therefore a parameter (e.g. a variable parameter) of the reverberator 100.

The filters 105 are delay line attenuation filters. The filters 105 can be used to control the RT60 parameter of the reverberator.

The output generator 107 can be used to generate spatialized virtual loudspeaker signals surrounding a listener.

As noted above, in some example embodiments, the parameters of the reverberator 100 may be defined such that the result of the processing of the virtual audio samples based on first reverberation parameters is audible to the user. By way of example, settings of one or more of the filters 102 and 104 may be adjusted such that an energy level output by the reverberator 100 is above a threshold level. One approach to implement this might be to look at the spectrum of the sound before and after applying reverberation and to then consider the differences of the energies in different frequency bands to see if there is an audible difference. If not, the difference could be amplified, for example using the filter 102 which can be used to control the level and spectrum of the output of the reverberator.

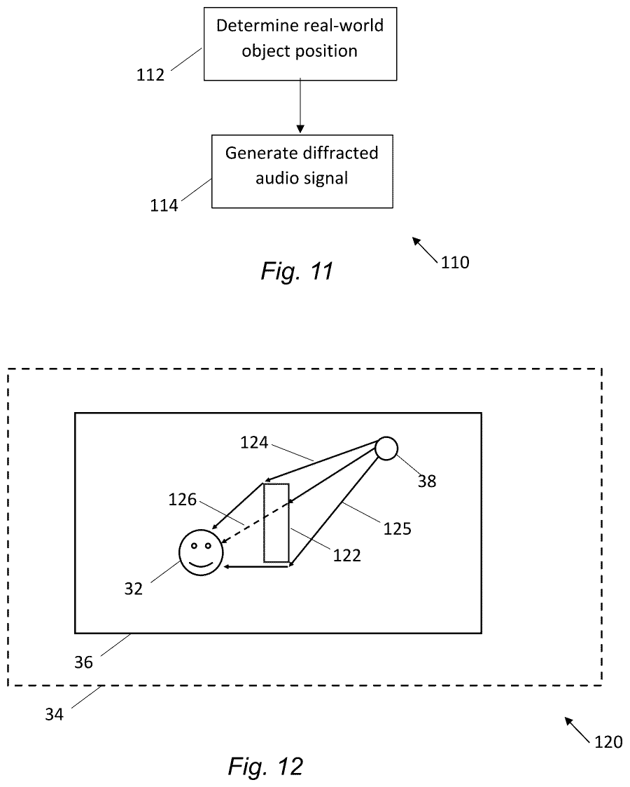

FIG. 11 is a flow chart showing an algorithm, indicated generally by the reference numeral 110, in accordance with an example embodiment.

The algorithm 110 starts at operation 112, where a real-world position of an object within a system is determined.

In the event that the position of the object (as determined in the operation 112) is between a position of a virtual sound signal and a user (such as the virtual object 38 and the user 32 in the example embodiments described above) then, at operation 114, audio samples are processed to generate a modelled diffracted audio signal, wherein the audio output is based, at least in part, on a sum of some or all of the modelled diffracted audio signal, the first reverberation signal and the second reverberation signal.

FIG. 12 is a schematic view of a scenario, indicated generally by the reference numeral 120, in accordance with an example embodiment. The scenario 120 shows an example implementation of the algorithm 110.

The scenario 120 includes the user 32, the virtual space 34, the real-world space 36 and the virtual object 38 described above. Also shown is a real-world object in the form of a cabinet 122.

A first audio beam 124 that would pass just above the cabinet 122 and a second audio beam 125 that would pass just below the cabinet 122 are shown. Also shown in a direct path beam 126 between the virtual object 38 and the user 32.

In the scenario 120, the physical object (in this case the cabinet 122) causes sound diffraction around it. Thus, sound from the first audio beam 124 and the second audio beam 125 are both bent towards the user. This sound diffraction effect is created around the cabinet 122 so that the user can be made aware of the proximity of the cabinet obstacle. Alternatively, or in addition, the direct path 126 can be partially (or completed) blocked by the cabinet 122 (as indicated by the dotted arrow).

In this way, the user 32 can be made aware of the presence of a real-world object (the cabinet 122) in a subtle way, making it less likely that the user that is moving around the virtual space 34 will accidentally walk into the object.

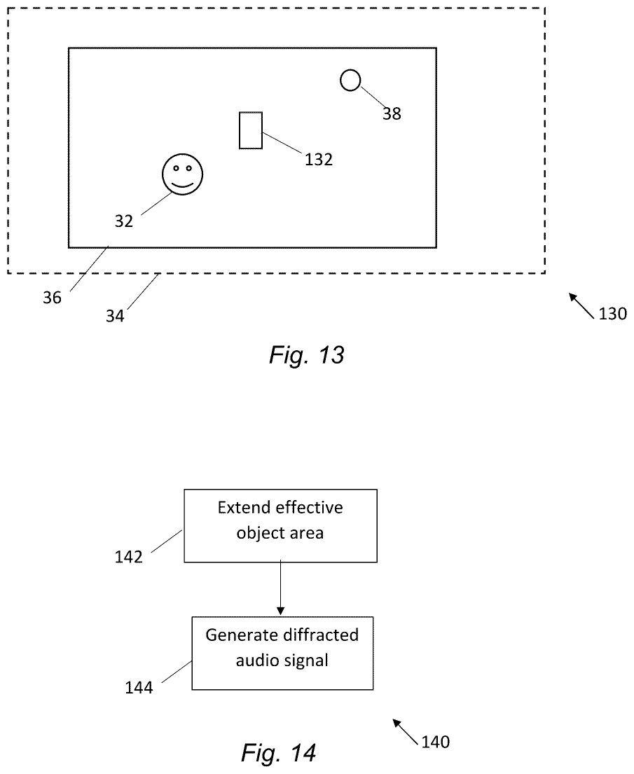

FIG. 13 is a schematic view of a scenario, indicated generally by the reference numeral 130, in accordance with an example embodiment. The scenario 120 includes the user 32, the virtual space 34, the real-world space 36 and the virtual object 38 described above. Also shown is a real-world object 132 that may be similar to the cabinet 122 described above.

FIG. 14 is a flow chart showing an algorithm, indicated generally by the reference numeral 140, in accordance with an example embodiment.

The algorithm 140 starts at operation 142, where an effective area of a real-world object (e.g. the real-world object 132) is extended, as discussed further below. At operation 144, a diffracted audio signal is generated based on the extended dimensions of the object (rather than the real-world dimensions of the object) when processing a virtual audio signal to generate said diffracted audio signal (e.g. in the event that the diffraction effect of the unextended object is below a threshold level). Thus, if the real-world object is too small to have a significant diffraction effect, then the dimensions of the object can be increased to exaggerate that effect. Alternatively, or in addition, the degree to which the dimensions of the object are extended (or even whether the dimensions are extended at all) may be dependent, at least in part, on the relative importance of the object. For example, the effective dimensions of a very expensive ornament present within the real-world space 36 may be extended significantly, whilst a wooden table may not be extended as much (or event at all).

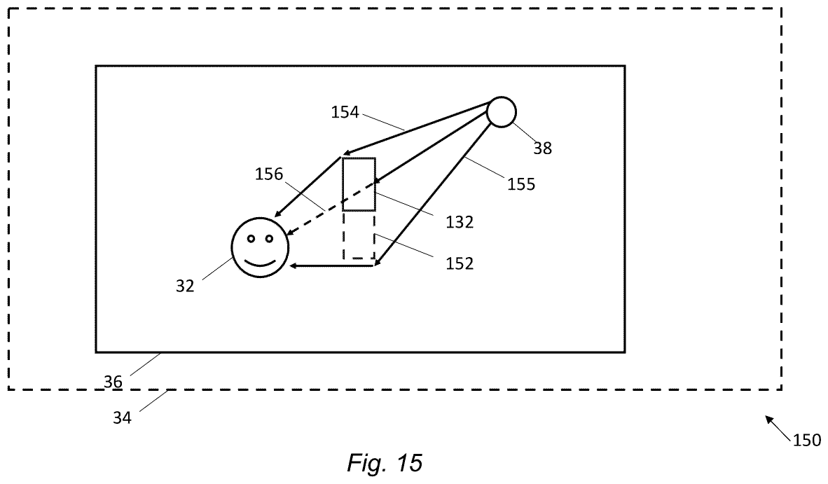

FIG. 15 is a schematic view of a scenario, indicated generally by the reference numeral 140, in accordance with an example embodiment. The scenario 150 includes the user 32, the virtual space 34, the real-world space 36, the virtual object 38, and the real-world object 132 described above. Also shown (in dotted form) is an extension 152 to the effective dimensions of the real-world object 132.

A first audio beam 154 that would pass just above the real-world object 132 and a second audio beam 155 that would pass just below the extension 152 to the real-world object 132 are shown. Also shown in a direct path beam 156 between the virtual object 38 and the user 32.

In the scenario 150, the physical object causes sound diffraction around it, but the diffraction effect is made greater (and more apparent to a user) by increasing the apparent dimensions of the real-world object 132. The direct path beam 156 can be partially (or completed) blocked by the real-world object 132 (as indicated by the dotted arrow).

In this way, the presence of a physical object that would otherwise be too small to create an audible effect may be detectable to the user 32.

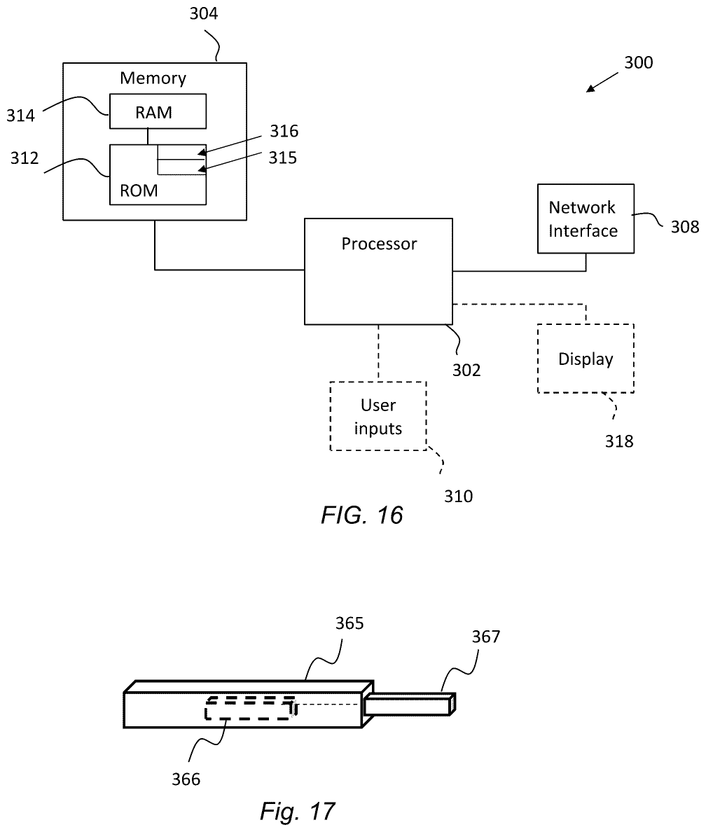

For completeness, FIG. 16 is a schematic diagram of components of one or more of the example embodiments described previously, which hereafter are referred to generically as a processing system 300. The processing system 300 may, for example, be the apparatus referred to in the claims below.

The processing system 300 may have a processor 302, a memory 304 closely coupled to the processor and comprised of a RAM 314 and a ROM 312, and, optionally, a user input 310 and a display 318. The processing system 300 may comprise one or more network/apparatus interfaces 308 for connection to a network/apparatus, e.g. a modem which may be wired or wireless. The network/apparatus interface 308 may also operate as a connection to other apparatus such as device/apparatus which is not network side apparatus. Thus, direct connection between devices/apparatus without network participation is possible.

The processor 302 is connected to each of the other components in order to control operation thereof.

The memory 304 may comprise a non-volatile memory, such as a hard disk drive (HDD) or a solid state drive (SSD). The ROM 312 of the memory 304 stores, amongst other things, an operating system 315 and may store software applications 316. The RAM 314 of the memory 304 is used by the processor 302 for the temporary storage of data. The operating system 315 may contain code which, when executed by the processor implements aspects of the algorithms 50, 60, 110 and 140 described above. Note that in the case of small device/apparatus the memory can be most suitable for small size usage i.e. not always a hard disk drive (HDD) or a solid state drive (SSD) is used.

The processor 302 may take any suitable form. For instance, it may be a microcontroller, a plurality of microcontrollers, a processor, or a plurality of processors.

The processing system 300 may be a standalone computer, a server, a console, or a network thereof. The processing system 300 and needed structural parts may be all inside device/apparatus such as IoT device/apparatus i.e. embedded to very small size.

In some example embodiments, the processing system 300 may also be associated with external software applications. These may be applications stored on a remote server device/apparatus and may run partly or exclusively on the remote server device/apparatus. These applications may be termed cloud-hosted applications. The processing system 300 may be in communication with the remote server device/apparatus in order to utilize the software application stored there.

FIG. 17 shows a tangible media, in the form of a removable memory unit 365, storing computer-readable code which when run by a computer may perform methods according to example embodiments described above. The removable memory unit 365 may be a memory stick, e.g. a USB memory stick, having internal memory 366 storing the computer-readable code. The internal memory 366 may be accessed by a computer system via a connector 367. Of course, other forms of tangible storage media may be used, as will be readily apparent to those of ordinary skilled in the art. Tangible media can be any device/apparatus capable of storing data/information which data/information can be exchanged between devices/apparatus/network.

Embodiments of the present invention may be implemented in software, hardware, application logic or a combination of software, hardware and application logic. The software, application logic and/or hardware may reside on memory, or any computer media. In an example embodiment, the application logic, software or an instruction set is maintained on any one of various conventional computer-readable media. In the context of this document, a “memory” or “computer-readable medium” may be any non-transitory media or means that can contain, store, communicate, propagate or transport the instructions for use by or in connection with an instruction execution system, apparatus, or device, such as a computer.

Reference to, where relevant, “computer-readable medium”, “computer program product”, “tangibly embodied computer program” etc., or a “processor” or “processing circuitry” etc. should be understood to encompass not only computers having differing architectures such as single/multi-processor architectures and sequencers/parallel architectures, but also specialized circuits such as field programmable gate arrays FPGA, application specify circuits ASIC, signal processing devices/apparatus and other devices/apparatus. References to computer program, instructions, code etc. should be understood to express software for a programmable processor firmware such as the programmable content of a hardware device/apparatus as instructions for a processor or configured or configuration settings for a fixed function device/apparatus, gate array, programmable logic device/apparatus, etc.

If desired, the different functions discussed herein may be performed in a different order and/or concurrently with each other. Furthermore, if desired, one or more of the above-described functions may be optional or may be combined. Similarly, it will also be appreciated that the flow diagrams of FIGS. 5, 6, 11 and 14 are examples only and that various operations depicted therein may be omitted, reordered and/or combined.

It will be appreciated that the above-described example embodiments are purely illustrative and are not limiting on the scope of the invention. Other variations and modifications will be apparent to persons skilled in the art upon reading the present specification.

Moreover, the disclosure of the present application should be understood to include any novel features or any novel combination of features either explicitly or implicitly disclosed herein or any generalization thereof and during the prosecution of the present application or of any application derived therefrom, new claims may be formulated to cover any such features and/or combination of such features.

Although various aspects of the invention are set out in the independent claims, other aspects of the invention comprise other combinations of features from the described example embodiments and/or the dependent claims with the features of the independent claims, and not solely the combinations explicitly set out in the claims.

It is also noted herein that while the above describes various examples, these descriptions should not be viewed in a limiting sense. Rather, there are several variations and modifications which may be made without departing from the scope of the present invention as defined in the appended claims.

1-15. (canceled)

16. An apparatus, comprising:
at least one processor; and
at least one memory storing instructions that, when executed by the at least one processor, cause the apparatus at least to:
obtain a virtual audio signal from one or more virtual sound signals of a virtual environment for presentation to a user, wherein the virtual audio signal comprises a plurality of virtual audio samples;
process the virtual audio samples based on first reverberation parameters to generate a first reverberation signal for samples up to a first threshold time following the respective virtual audio sample being obtained, wherein the first reverberation parameters are dependent, at least in part, on a geometry of a real-world space in which a user is located;
process the virtual audio samples based on second reverberation parameters to generate a second reverberation signal for samples beyond a second threshold time following the respective virtual audio sample being obtained, wherein the second reverberation parameters are dependent, at least in part, on a geometry of the virtual environment; and
generate an audio output for presentation to the user, where the audio output is based, at least in part, on a sum of the first and second reverberation signals.

17. An apparatus as claimed in claim 16, wherein the apparatus is further caused to process a direct path virtual audio signal, wherein the audio output is based, at least in part, on a sum of the processed direct path audio signal, the first reverberation signal and the second reverberation signal.

18. An apparatus as claimed in claim 17, wherein processing said direct path virtual audio signal comprises filtering the direct path virtual audio signal based on room simulation dependent effects.

19. An apparatus as claimed in claim 16, wherein the first reverberation parameters are based, at least in part, on boundaries of the real-world space.

20. An apparatus as claimed in claim 16, wherein the second reverberation parameters are based, at least in part, on boundaries of the virtual environment.

21. An apparatus as claimed in claim 16, wherein the first and second thresholds times are the same.

22. An apparatus as claimed in claim 16, wherein the first reverberation parameters are defined such that the first reverberation signal generated by the processing of the virtual audio samples based on first reverberation parameters is audible to the user.

23. An apparatus as claimed in claim 16, wherein the first reverberation signal comprises discrete directional reflections.

24. An apparatus as claimed in claim 16, further comprising a delay line for use in processing said virtual audio samples.

25. An apparatus as claimed in claim 16, wherein the apparatus is further caused to:
detect a real-world object between a position of a virtual sound source and the user; and
process the virtual audio samples to generate a modelled diffracted audio signal in the event that a real-world object is detected between the position of the virtual sound signal and the user, wherein the audio output is based, at least in part, on a sum of the modelled diffracted audio signal, the first reverberation signal and the second reverberation signal.

26. An apparatus as claimed in claim 25, wherein the apparatus is further caused to determine whether an amount of diffraction caused to the modelled diffracted audio signal is below a threshold level, wherein processing the virtual audio signal comprises generating the modelled diffracted audio signal based on an extended effective area of the real-world object in the event that the diffraction effect is below said threshold level.

27. An apparatus as claimed in claim 16, wherein the apparatus is further caused to present the generated audio output to the user.

28. A method comprising:
obtaining a virtual audio signal from one or more virtual sound signals of a virtual environment for presentation to a user, wherein the virtual audio signal comprises a plurality of virtual audio samples;
processing the virtual audio samples based on first reverberation parameters to generate a first reverberation signal for samples up to a first threshold time following the respective virtual audio sample being obtained, wherein the first reverberation parameters are dependent, at least in part, on a geometry of a real-world space in which a user is located;
processing the virtual audio samples based on second reverberation parameters to generate a second reverberation signal for samples beyond a second threshold time following the respective virtual audio sample being obtained, wherein the second reverberation parameters are dependent, at least in part, on a geometry of the virtual environment; and
generating an audio output for presentation to the user, where the audio output is based, at least in part, on a sum of the first and second reverberation signals.

29. A method as claimed in claim 28, further comprising processing a direct path virtual audio signal, wherein the audio output is based, at least in part, on a sum of the processed direct path audio signal, the first reverberation signal and the second reverberation signal.

30. A method as claimed in claim 29, wherein processing said direct path virtual audio signal comprises filtering the direct path virtual audio signal based on room simulation dependent effects.

31. A method as claimed in claim 28, wherein the first reverberation parameters are based, at least in part, on boundaries of the real-world space.

32. A method as claimed in claim 28, wherein the second reverberation parameters are based, at least in part, on boundaries of the virtual environment.

33. A method as claimed in claim 28, wherein the first and second thresholds times are the same.

34. A method as claimed in claim 28, wherein the first reverberation parameters are defined such that the first reverberation signal generated by the processing of the virtual audio samples based on first reverberation parameters is audible to the user.

35. A non-transitory computer readable medium comprising program instructions stored thereon for performing at least the following:
obtaining a virtual audio signal from one or more virtual sound signals of a virtual environment for presentation to a user, wherein the virtual audio signal comprises a plurality of virtual audio samples;
processing the virtual audio samples based on first reverberation parameters to generate a first reverberation signal for samples up to a first threshold time following the respective virtual audio sample being obtained, wherein the first reverberation parameters are dependent, at least in part, on a geometry of a real-world space in which a user is located;
processing the virtual audio samples based on second reverberation parameters to generate a second reverberation signal for samples beyond a second threshold time following the respective virtual audio sample being obtained, wherein the second reverberation parameters are dependent, at least in part, on a geometry of the virtual environment; and
generating an audio output for presentation to the user, where the audio output is based, at least in part, on a sum of the first and second reverberation signals.
